(19) United States
(12) Patent Application Publication
(10) Pub. No.: US 2006/0133677 A1
(43) Pub. Date: Jun. 22, 2006

(54) Method and apparatus for performing residual prediction of image block when encoding/decoding video signal

(76) Inventors: Seung Wook Park, Sungnam-si (KR); Ji Ho Park, Sungnam-si (KR); Byeong Moon Jeon, Sungnam-si (KR)

Correspondence Address: HARNESS, DICKEY & PIERCE, P.L.C., P.O. BOX 8910, RESTON, VA, 20195, US

(21) Appl. No.: 11/293,159

(22) Filed: Dec. 5, 2005

Related U.S. Application Data
(60) Provisional application No. 60/632,993, filed on Dec. 6, 2004.

(30) Foreign Application Priority Data
Jun. 20, 2005 (KR) 10-2005-0052949

(51) Int. Cl. G06K 9/36

(52) U.S. Cl. 382/236

(57) ABSTRACT

A method and apparatus for scalably encoding and decoding a video signal is provided. During encoding, prediction is performed on an image block to produce residual data of the image block, and the residual data of the image block is selectively coded into a residual difference from residual data of a block of a base layer, which spatially corresponds to the image block and is present in a base layer frame temporally coincident with a frame including the image block. Whether to code the image block into the residual difference is determined based on the difference between coding information (motion vectors or block pattern (CBP) information) of the image block and coding information of the corresponding block. Separate information indicating whether or not the image data has been coded into the residual difference is not transmitted to the decoder even if the image data has been coded into the residual difference.

### DOMESTIC PRIORITY INFORMATION

This application claims priority under 35 U.S.C. §119 on U.S. provisional application 60/632,993, filed Dec. 6, 2004; the entire contents of which are hereby incorporated by reference.

### FOREIGN PRIORITY INFORMATION

This application claims priority under 35 U.S.C. §119 on Korean Application No. 10-2005-0052949, filed Jun. 20, 2005; the entire contents of which are hereby incorporated by reference.

### BACKGROUND OF THE INVENTION

1. Field of the Invention

The present invention relates to a method and apparatus for encoding and decoding residual data when performing scalable encoding and decoding of a video signal.

2. Description of the Related Art

Scalable Video Codec (SVC) is a scheme which encodes video into a sequence of pictures with the highest image quality while ensuring that part of the encoded picture sequence (specifically, a partial sequence of frames intermittently selected from the total sequence of frames) can be decoded and used to represent the video with a low image quality. Motion Compensated Temporal Filtering (MCTF) is an encoding scheme that has been suggested for use in the scalable video codec.

Although it is possible to represent low image-quality video by receiving and processing part of a sequence of pictures encoded in the scalable MCTF coding scheme as described above, there is still a problem in that the image quality is significantly reduced if the bitrate is lowered. One solution to this problem is to provide an auxiliary picture sequence for low bitrates, for example, a sequence of pictures that have a small screen size and/or a low frame rate.

The auxiliary picture sequence is referred to as a base layer, and the main picture sequence is referred to as an enhanced or enhancement layer. Video signals of the base and enhanced layers have redundancy since the same video signal source is encoded into two layers. To increase the coding efficiency of the enhanced layer according to the MCTF scheme, one method converts each video frame of the enhanced layer into a predictive image based on a video frame of the base layer temporally coincident with the enhanced layer video frame. Another method codes motion vectors of a picture in the enhanced layer using motion vectors of a picture in the base layer temporally coincident with the enhanced layer picture. FIG. 1 illustrates a procedure for coding an enhanced layer block using coded data of a base layer picture.

The image block coding procedure of FIG. 1 is performed in the following manner. First, motion estimation and prediction is performed on the current image block to find a reference block of the image block in an adjacent frame prior to and/or subsequent to the image block and to code data of the image block into image difference data (i.e., residual data) from data of the reference block. If the image block (M10 or M12 in the example of FIG. 1) has a corresponding block (BM10 or BM11) in the base layer, it is determined whether to code the residual data of the image block into a difference from coded residual data of the corresponding block.

If a base layer frame has a smaller size than an enhanced layer frame, the corresponding block BM10 or BM11 or a corresponding area C_B10 or C_B11, which would be a block spatially co-located with the image block M10 or M12 if it were enlarged, is enlarged by the frame size ratio, and it is determined whether to code the residual data of the image block into a difference from residual data of the enlarged block EM10 or EM11.

The determination as to whether to code the image block into the residual difference is made according to a cost function based on the amount of information and the image quality. If it is determined that the image block is to be coded into the residual difference, residual difference data is obtained by subtracting residual data of the enlarged corresponding block EM10 or EM11 from the residual data of the image block, and the obtained residual difference data is coded into the current block M10 or M12. This process is referred to as a residual prediction operation. Then, a flag “residual_prediction flag”, which indicates whether or not the current block has been coded into the residual difference, is set to “1” in a header of the current image block.

For each block with the flag “residual_prediction_flag” set to “1”, a decoder reconstructs original residual data of the block by adding residual data of a corresponding block of the base layer to residual difference data of the block, and then reconstructs original image data of the block based on data of a reference block pointed to by a motion vector of the block.

### SUMMARY OF THE INVENTION

Therefore, the present invention has been made in view of such circumstances, and it is an object of the present invention to provide a method and apparatus for encoding/decoding a video signal in a scalable fashion, which eliminates information indicating whether or not residual prediction has been performed to reduce the amount of information, thereby increasing scalable coding efficiency.

In accordance with one aspect of the present invention, the above and other objects can be accomplished by the provision of a method and apparatus for encoding a video signal, wherein the video signal is encoded according to a scalable MCTF scheme to output a bitstream of a first layer while the video signal is encoded according to a specified scheme to output a bitstream of a second layer, and, when the video signal is encoded according to the scalable MCTF scheme, a prediction operation is performed on an image block included in an arbitrary frame of the video signal to produce residual data of the image block, and the residual data of the image block is selectively coded into difference data from residual data of a block, spatially corresponding to the image block, in a frame temporally coincident with the arbitrary frame and included in the bitstream of the second layer, based on the difference between coding information of the image block and coding information of the corresponding block.

In accordance with another aspect of the present invention, there is provided a method and apparatus for decoding a video signal, wherein, when an encoded bitstream of a first layer and an encoded bitstream of a second layer are received and decoded, data of a block, which spatially corresponds to a target block in an arbitrary frame in the bitstream of the first layer and which is included in a frame in the bitstream of the second layer temporally coincident with the arbitrary frame, is selectively added to data of the target block based on the difference between coding information of the target block and coding information of the corresponding block before original pixel data of the target block is reconstructed based on data of a reference block of the target block.

In an embodiment of the present invention, the residual prediction operation is performed (i.e., the residual data of the image block is coded into the difference data from the residual data of the corresponding block) when the absolute difference between a motion vector of the image block and a motion vector obtained by scaling a motion vector of the corresponding block by the ratio of resolution of the first layer to resolution of the second layer is less than or equal to a predetermined pixel distance.

In an embodiment of the present invention, the predetermined pixel distance is one pixel.

In another embodiment of the present invention, the residual prediction operation is performed when block pattern information of the image block is identical to block pattern information of the corresponding block.

In an embodiment of the present invention, frames of the second layer have a smaller screen size (or lower resolution) than frames of the first layer.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates how an enhanced layer block is coded using coded data of a base layer picture;

FIG. 2 is a block diagram of a video signal encoding apparatus to which a scalable video signal coding method according to the present invention is applied;

FIG. 3 illustrates part of a filter for performing image estimation/prediction and update operations in an MCTF encoder in FIG. 2;

FIG. 4 illustrates a residual prediction operation according to an embodiment of the present invention;

FIG. 5 illustrates a residual prediction operation according to another embodiment of the present invention;

FIG. 6 is a block diagram of an apparatus for decoding a data stream encoded by the apparatus of FIG. 2; and

FIG. 7 illustrates main elements of an MCTF decoder shown in FIG. 6 for performing inverse prediction and update operations.

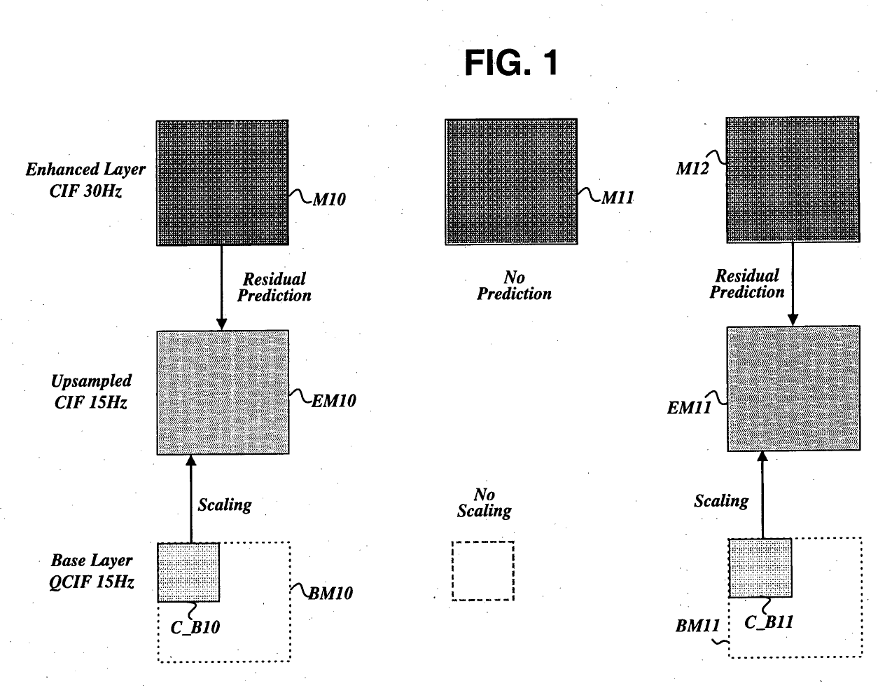

### DESCRIPTION OF EXAMPLE EMBODIMENTS

Preferred embodiments of the present invention will now be described in detail with reference to the accompanying drawings.

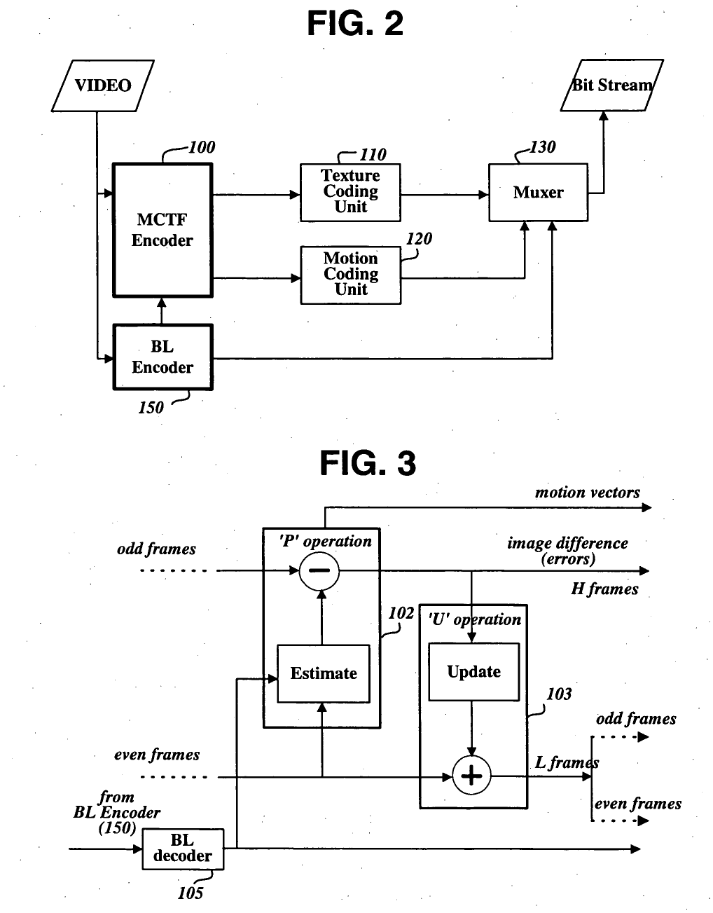

FIG. 2 is a block diagram of a video signal encoding apparatus to which a scalable video signal coding method according to the present invention is applied.

The video signal encoding apparatus shown in FIG. 2 comprises an MCTF encoder 100 to which the present invention is applied, a texture coding unit 110, a motion coding unit 120, a base layer encoder 150, and a muxer (or multiplexer) 130. The MCTF encoder 100 encodes an input video signal on a per macroblock basis according to an MCTF scheme and generates suitable management information. The texture coding unit 110 converts information of encoded macroblocks into a compressed bitstream. The motion coding unit 120 codes motion vectors of image blocks obtained by the MCTF encoder 100 into a compressed bitstream according to a specified scheme. The base layer encoder 150 encodes an input video signal according to a specified scheme, for example, according to the MPEG-1, 2 or 4 standard or the H.261, H.263 or H.264 standard, and produces a small-screen picture sequence, for example, a sequence of pictures which are scaled down to 25% of their original size (i.e., scaled down by ½, which is the ratio of the length of one side of a small-screen picture to that of a normal picture). The muxer 130 encapsulates the output data of the texture coding unit 110, the picture sequence output from the base layer encoder 150, and the output vector data of the motion coding unit 120 into a predetermined format. The muxer 130 then multiplexes and outputs the encapsulated data into a predetermined transmission format. The base layer encoder 150 can provide a low-bitrate data stream not only by encoding an input video signal into a sequence of pictures having a smaller screen size than pictures of the enhanced layer but also by encoding an input video signal into a sequence of pictures having the same screen size as pictures of the enhanced layer at a lower frame rate than the enhanced layer. In the embodiments of the present invention described below, the base layer is encoded into a small-screen picture sequence.

The MCTF encoder 100 performs motion estimation and prediction operations on each target macroblock in a video frame. The MCTF encoder 100 also performs an update operation for each target macroblock by adding an image difference of the target macroblock from a corresponding macroblock in a neighbor frame to the corresponding macroblock in the neighbor frame. FIG. 3 illustrates main elements of a filter that performs these operations.

The MCTF encoder 100 separates an input video frame sequence into odd and even frames and then performs estimation/prediction and update operations on a certain-length sequence of pictures, for example, on a Group Of Pictures (GOP), a plurality of times until the number of L frames, which are produced by the update operation, is reduced to one. FIG. 3 shows elements associated with estimation/prediction and update operations at one of a plurality of MCTF levels.

The elements of FIG. 3 include an estimator/predictor 102, an updater 103, and a base layer (BL) decoder 105. The BL decoder 105 functions to extract a motion vector of each motion-estimated (inter-frame mode) macroblock from a stream encoded by the base layer encoder 150 and also to upsample (or enlarge) the macroblock by a frame size (or resolution) ratio between the enhanced and base layers. Through motion estimation, the estimator/predictor 102 searches for a reference block of each target macroblock of a current frame, which is to be coded to residual data, in a neighbor frame prior to or subsequent to the current frame and determines a motion vector of the target macroblock with respect to the reference block. The estimator/predictor 102 then determines an image difference (i.e., a pixel-to-pixel difference) of the target macroblock from the reference block. If a block corresponding to the target macroblock is present in the base layer, the estimator/predictor 102 determines whether to code the target macroblock into the difference of residual data of the target macroblock from residual data of the corresponding block. The updater 103 performs an update operation for a macroblock, whose reference block has been found via motion estimation, by multiplying the image difference of the macroblock by an appropriate constant (for example, ½ or ¼) and adding the resulting value to the reference block. The operation carried out by the updater 103 is referred to as a ‘U’ operation, and a frame produced by the ‘U’ operation is referred to as an ‘L’ frame.

The estimator/predictor 102 and the updater 103 of FIG. 3 may perform their operations on a plurality of slices, which are produced by dividing a single frame, simultaneously and in parallel instead of performing their operations on the video frame. A frame (or slice) having an image difference (i.e., a predictive image), which is produced by the estimator/predictor 102, is referred to as an ‘H’ frame (or slice). The difference data in the ‘H’ frame (or slice) reflects high frequency components of the video signal. In the following description of the embodiments, the term ‘frame’ is used in a broad sense to include a ‘slice’, provided that replacement of the term ‘frame’ with the term ‘slice’ is technically equivalent.

More specifically, the estimator/predictor 102 divides each of the input video frames (or each L frame obtained at the previous level) into macroblocks of a predetermined size. Through inter-frame motion estimation, the estimator/predictor 102 searches for a macroblock most highly correlated with a target macroblock of a current frame in adjacent frames prior to and/or subsequent to the current frame. The estimator/predictor 102 then codes an image difference of the target macroblock from the found macroblock. If a block corresponding to the target macroblock is present in the base layer, the estimator/predictor 102 determines whether to perform a residual prediction operation on the target macroblock according to a method described below and codes the target macroblock accordingly. Such an operation of the estimator/predictor 102 is referred to as a ‘P’ operation. The block most highly correlated with a target block is a block having the smallest image difference from the target block. The image difference of two image blocks is defined, for example, as the sum or average of pixel-to-pixel differences of the two image blocks. The block having the smallest image difference is referred to as a reference block. One reference block may be present in each of the reference frames and thus a plurality of reference blocks may be present for each target macroblock.

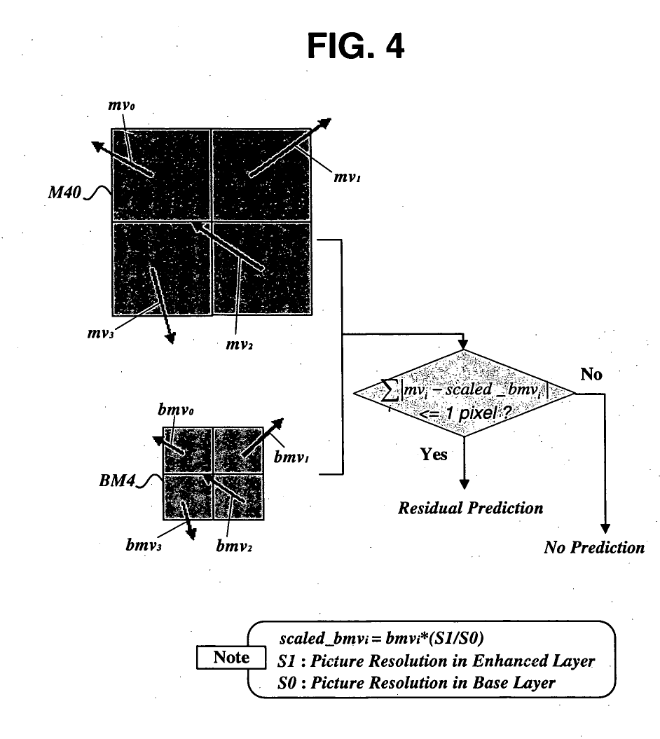

The residual prediction operation of an image block will now be described in detail. FIG. 4 illustrates a residual prediction operation according to an embodiment of the present invention. The estimator/predictor 102 obtains motion vector-related information of a block BM4 of the base layer corresponding to a current macroblock M40 from encoding information provided from the BL decoder 105. The corresponding block BM4 is a block which is temporally coincident with the macroblock M40 and which would be spatially co-located with the macroblock M40 in the frame if it were enlarged. Each motion vector of the base layer is determined by the base layer encoder 150, and the motion vector is carried in a header of each macroblock and a frame rate is carried in a GOP header. The BL decoder 105 extracts necessary encoding information, which includes a frame time, a frame size, and a block mode and motion vector of each macroblock, from the header, without decoding the encoded video data, and provides the extracted information to the estimator/predictor 102. The BL decoder 105 also provides encoded residual data of each block to the estimator/predictor 102.

The estimator/predictor 102 receives information of a motion vector (bmv) of the corresponding block BM4 from the BL decoder 105 and scales up the motion vector of the corresponding block BM4 by the frame size or resolution ratio between the layers (for example, by a factor of 2). The estimator/predictor 102 then determines the difference between the motion vector of the corresponding block BM4 and a motion vector determined for the current macroblock M40. For example, when a current 16×16 macroblock M40 is divided into 4 sub-blocks to be predicted as shown in FIG. 4, the estimator/predictor 102 determines the absolute differences between motion vectors mv0 to mv3 of the sub-blocks of the current macroblock M40 and motion vectors scaled from motion vectors bmv0 to bmv3 of the corresponding block BM4, and determines the sum S of the absolute vector differences

$${(}^{S = {\sum }_{i} \vert {mv}_{i} - {scaled\_bmv}_{i} \vert} ) .$$

Although not illustrated in the figure, motion vectors of chroma blocks can also be used to determine the vector difference sum.

If the vector difference sum S is less than or equal to one pixel when motion vectors are represented at quarter-pixel resolution, the estimator/predictor 102 subtracts residual data of the scaled corresponding block BM4 provided from the BL decoder 105 from the current macroblock M40, which has been previously coded into residual data, thereby coding the current macroblock M40 into a residual difference. If the vector difference sum S is larger than one pixel, the estimator/predictor 102 does not code the current macroblock M40 into a residual difference. In this manner, the residual prediction operation is selectively performed according to the condition

$$( {\sum }_{i} \vert {mv}_{i} - {scaled\_bmv}_{i} \vert \leq 1 pixel ) ,$$

and information indicating whether or not the macroblock has been coded into a residual difference is not separately recorded in a header of the macroblock. In other words, the sum of the absolute differences between the motion vectors of the sub-blocks of the current macroblock and the scaled motion vectors of the corresponding block is compared with a predetermined threshold, and the residual prediction operation is selectively performed according to the result of the comparison. Information indicating whether or not the macroblock has been coded into a residual difference is not separately recorded in the header of the macroblock since the decoder determines, based on the same condition, whether or not the macroblock has been coded into a residual difference.

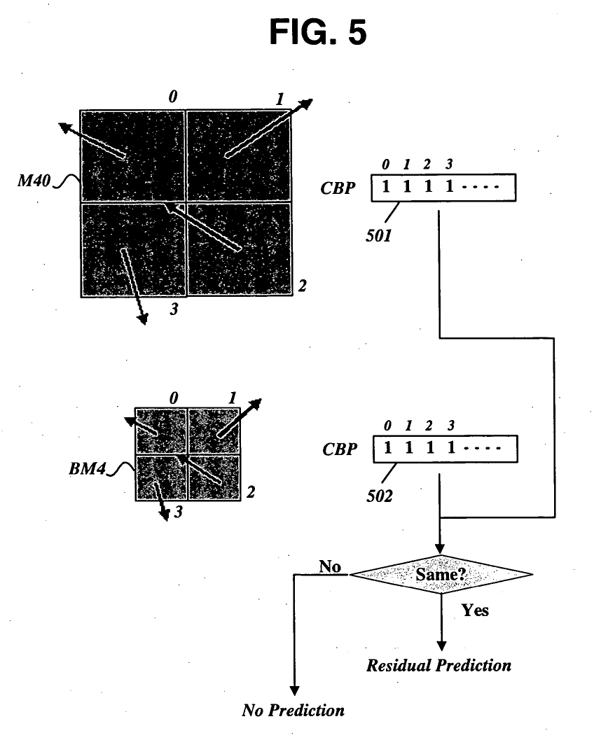

A residual prediction operation according to another embodiment of the present invention will now be described with reference to FIG. 5.

The estimator/predictor 102 performs motion estimation/prediction operations on a macroblock M40 to code it into residual data, and records a coded block pattern (CBP) 501 of the macroblock M40, which is information regarding a pattern of the coded residual data of the macroblock M40, in a header of the macroblock M40. For example, the estimator/predictor 102 performs prediction on the current macroblock M40 divided into 8×8 sub-blocks, and records “1” in a bit field for a sub-block in the CBP 501 if residual data of the sub-block has a value of “0”, otherwise the estimator/predictor 102 records “0” in the bit field. The base layer encoder 150 also performs this operation, so that encoding information received from the BL decoder 105 includes CBP information 502 of the corresponding block.

The estimator/predictor 102 compares the CBP information of the current macroblock M40 with the CBP information of the corresponding block BM4 (or part of the CBP information regarding an area corresponding to the current macroblock M40). The CBP information for comparison may include a bit field assigned to a chroma block. If the CBP information of the current macroblock M40 is identical to the CBP information of the corresponding block BM4, the estimator/predictor 102 subtracts residual data of the scaled corresponding block BM4 provided from the BL decoder 105 from the current macroblock M40, which has been previously coded into residual data, thereby coding the current macroblock M40 into a residual difference. If the CBP information of the current macroblock M40 is different from the CBP information of the corresponding block BM4, the estimator/predictor 102 does not code the current macroblock M40 into a residual difference. In this manner, the residual prediction operation is selectively performed according to whether or not the CBP information of the current macroblock M40 is identical to that of the corresponding block BM4, and information indicating whether or not the macroblock has been coded into a residual difference is not separately recorded in a header of the macroblock. That is, even if corresponding image blocks in the base and enhanced layers have different motion vectors, the residual prediction operation is performed if the corresponding image blocks have the same information regarding the pattern of the residual data.

A data stream including a sequence of L and H frames including blocks coded according to the method described above is transmitted by wire or wirelessly to a decoding apparatus or is delivered via recording media. The decoding apparatus reconstructs the original video signal of the enhanced and/or base layer according to the method described below.

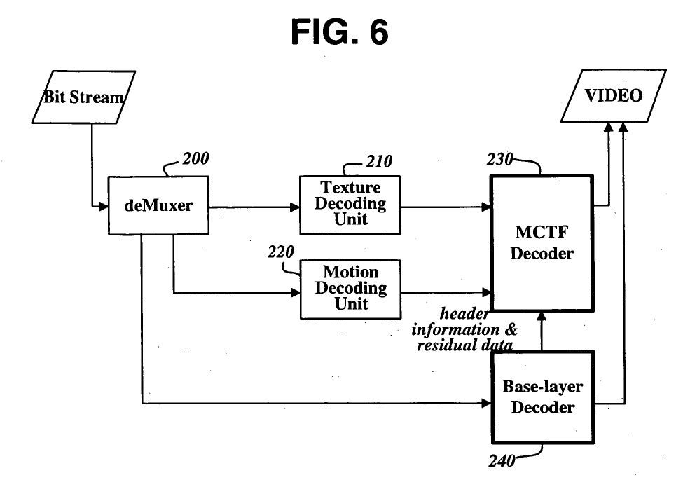

FIG. 6 is a block diagram of an apparatus for decoding a data stream encoded by the apparatus of FIG. 2. The decoding apparatus of FIG. 6 includes a demuxer (or demultiplexer) 200, a texture decoding unit 210, a motion decoding unit 220, an MCTF decoder 230, and a base layer (BL) decoder 240. The demuxer 200 separates a received data stream into a compressed motion vector stream, a compressed macroblock information stream, and a base layer stream. The texture decoding unit 210 reconstructs the compressed macroblock information stream to its original uncompressed state. The motion decoding unit 220 reconstructs the compressed motion vector stream to its original uncompressed state. The MCTF decoder 230 converts the uncompressed macroblock information stream and the uncompressed motion vector stream back to an original video signal according to an MCTF scheme. The BL decoder 240 decodes the base layer stream according to a specified scheme, for example, according to the MPEG-4 or H.264 standard. The BL decoder 240 not only decodes an input base layer stream but also provides header information in the stream to the MCTF decoder 230 to allow the MCTF decoder 230 to use necessary encoding information of the base layer, for example, information regarding the motion vector. The BL decoder 240 also provides undecoded residual data of each block to the MCTF decoder 230.

The MCTF decoder 230 includes main elements for reconstructing an input stream to an original frame sequence.

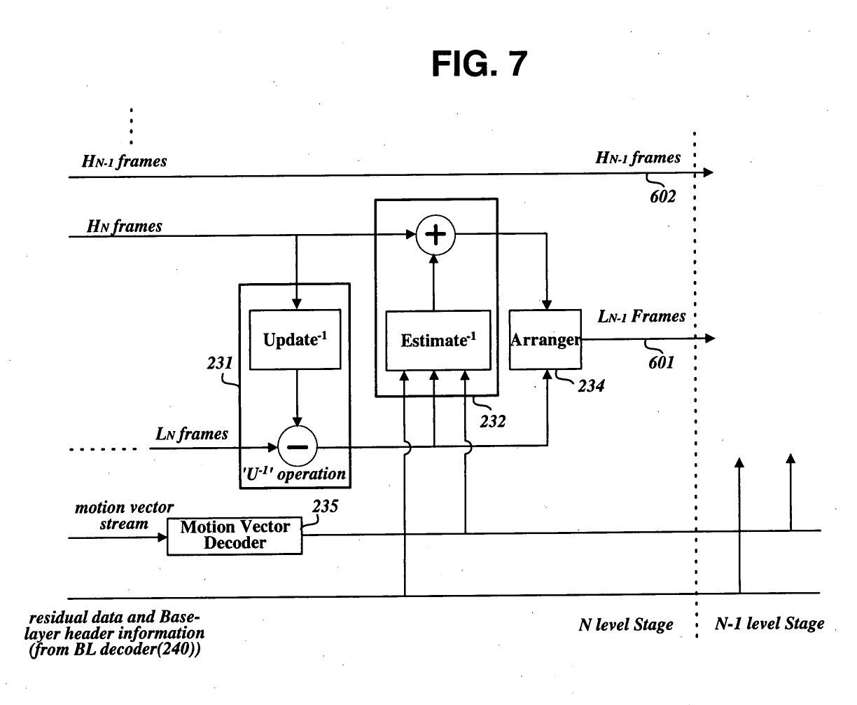

FIG. 7 illustrates an example of the main elements of the MCTF decoder 230 for reconstructing a sequence of H and L frames of MCTF level N to an L frame sequence of MCTF level N−1. The elements of the MCTF decoder 230 shown in FIG. 7 include an inverse updater 231, an inverse predictor 232, a motion vector decoder 235, and an arranger 234. The inverse updater 231 subtracts pixel difference values of input H frames from corresponding pixel values of input L frames. The inverse predictor 232 reconstructs input H frames to L frames having original images using the H frames and the L frames, from which the image differences of the H frames have been subtracted. The motion vector decoder 235 decodes an input motion vector stream into motion vector information of macroblocks in H frames and provides the motion vector information to an inverse predictor (for example, the inverse predictor 232) of each stage. The arranger 234 interleaves the L frames completed by the inverse predictor 232 between the L frames output from the inverse updater 231, thereby producing a normal sequence of L frames.

L frames output from the arranger 234 constitute an L frame sequence 601 of level N−1. A next-stage inverse updater and predictor of level N−1 reconstructs the L frame sequence 601 and an input H frame sequence 602 of level N−1 to an L frame sequence. This decoding process is performed the same number of times as the number of MCTF levels employed in the encoding procedure, thereby reconstructing an original video frame sequence.

A more detailed description will now be given of how H frames of level N are reconstructed to L frames according to the present invention. First, for an input L frame, the inverse updater 231 subtracts error values (i.e., image differences) of macroblocks in all H frames, whose image differences have been obtained using blocks in the L frame as reference blocks, from the blocks of the L frame.

For a macroblock, coded through motion estimation, in an H frame, the inverse predictor 232 determines whether or not a residual prediction operation has been performed on the macroblock if a block corresponding to the macroblock is present in the base layer.

When the embodiment illustrated in FIG. 4 is applied, the inverse predictor 232 receives information of motion vectors of the corresponding block from the BL decoder 240 and scales the motion vectors of the corresponding block by a frame size or resolution ratio between the layers. The inverse predictor 232 then determines the sum S of the differences between motion vectors of the current macroblock and the scaled motion vectors of the corresponding block

$$( i . e . {,}^{ S = {\sum }_{i} \vert {mv}_{i} - {scaled\_bmv}_{i} \vert} ) .$$

If the determined vector difference sum S is less than or equal to one pixel, the inverse predictor 232 determines that the current macroblock has been coded into a residual difference. Then, the inverse predictor 232 adds residual data of the corresponding block of the base layer, which is provided from the BL decoder 240, to the current macroblock after enlarging (or scaling up) the corresponding block, thereby converting a residual difference of the current macroblock into original residual data. If the determined vector difference sum S is larger than one pixel, the inverse predictor 232 does not perform the operation for adding the residual data of the enlarged corresponding block to the current macroblock. Also when there is no block of the base layer corresponding to the current macroblock, the inverse predictor 232 does not perform the operation for adding the residual data.

After selectively performing the operation for adding the residual data of the corresponding area of the base layer to the macroblock according to the condition

$$( {\sum }_{i} \vert {mv}_{i} - {scaled\_bmv}_{i} \vert \leq 1 pixel ) ,$$

the inverse predictor 232 locates reference blocks of the macroblock in L frames with reference to the motion vectors of the macroblock provided from the motion vector decoder 235, and adds pixel values of the reference blocks to difference values (or residual data) of pixels of the macroblock, thereby reconstructing an original image of the macroblock.

When the embodiment illustrated in FIG. 5 is applied, the inverse predictor 232 compares CBP information of the current macroblock with CBP information (or part thereof) of a corresponding block of the base layer included in encoding information provided from the BL decoder 240. If the CBP information of the current macroblock is identical to that of the corresponding block, i.e., if the difference between values of the CBP information of the current macroblock and the corresponding block is 0, the inverse predictor 232 determines that the current macroblock has been coded into a residual difference. Then, the inverse predictor 232 adds residual data of the corresponding block of the base layer, which is provided from the BL decoder 240, to the current macroblock after enlarging (or scaling up) the corresponding block, thereby converting a residual difference of the current macroblock into original residual data. If the CBP information of the current macroblock is different from that of the corresponding block, i.e., if the difference between values of the CBP information of the current macroblock and the corresponding block is not 0, the inverse predictor 232 does not perform the operation for adding the residual data of the enlarged corresponding block to the current macroblock.

After selectively performing the inverse residual prediction operation according to whether or not the CBP information of the macroblock is identical to that of the corresponding block, the inverse predictor 232 locates reference blocks of the macroblock in L frames with reference to the motion vectors of the macroblock provided from the motion vector decoder 235, and adds pixel values of the reference blocks to difference values of pixels of the macroblock, thereby reconstructing an original image of the macroblock.

Such a procedure is performed for all macroblocks in the current H frame to reconstruct the current H frame to an L frame. The arranger 234 alternately arranges L frames reconstructed by the inverse predictor 232 and L frames updated by the inverse updater 231, and provides such arranged L frames to the next stage.

The above decoding method reconstructs an MCTF-encoded data stream to a complete video frame sequence. In the case where the estimation/prediction and update operations have been performed on a GOP P times in the MCTF encoding procedure described above, a video frame sequence with the original image quality is obtained if the inverse prediction and update operations are performed P times, whereas a video frame sequence with a lower image quality and at a lower bitrate is obtained if the inverse prediction and update operations are performed less than P times.

The decoding apparatus described above can be incorporated into a mobile communication terminal, a media player, or the like.

As is apparent from the above description, a method and apparatus for encoding and decoding a video signal in a scalable MCTF scheme according to the present invention determines whether or not a residual prediction operation has been performed on a block, based on the difference between a motion vector of the block and a motion vector of a corresponding block of the base layer, or based on whether or not CBP information of the block is identical to CBP information of the corresponding block, thereby eliminating a conventional residual prediction flag “residual_prediction_flag”. This reduces the amount of information transmitted for the video signal, thereby increasing MCTF coding efficiency.

Although this invention has been described with reference to the preferred embodiments, it will be apparent to those skilled in the art that various improvements, modifications, replacements, and additions can be made in the invention without departing from the scope and spirit of the invention. Thus, it is intended that the invention cover the improvements, modifications, replacements, and additions of the invention, provided they come within the scope of the appended claims and their equivalents.

What is claimed is:

1. An apparatus for encoding an input video signal, comprising:
a first encoder for encoding the video signal according to a first scheme and outputting a bitstream of a first layer; and
a second encoder for encoding the video signal according to a second scheme and outputting a bitstream of a second layer,
the first encoder including means for performing a prediction operation on an image block included in an arbitrary frame of the video signal to produce residual data of the image block, and selectively coding the residual data of the image block into difference data from residual data of a block, spatially corresponding to the image block, in a frame temporally coincident with the arbitrary frame and included in the bitstream of the second layer, based on a difference between coding information of the image block and coding information of the corresponding block.

2. The apparatus according to claim 1, wherein the coding information difference is an absolute difference between a motion vector of the image block and a motion vector obtained by scaling a motion vector of the corresponding block by a ratio of resolution of the first layer to resolution of the second layer.

3. The apparatus according to claim 2, wherein the means codes the residual data of the image block into the difference data from the residual data of the corresponding block if the absolute difference is less than or equal to one pixel.

4. The apparatus according to claim 1, wherein the coding information of a macroblock, which is divided into sub-blocks to be coded into residual data, is pattern information including bit information individually assigned to each of the sub-blocks, the bit information having a value determined according to whether or not a corresponding one of the sub-blocks includes data having a value other than 0.

5. The apparatus according to claim 4, wherein the means codes the residual data of the image block into the difference data from the residual data of the corresponding block if pattern information of the image block is identical to pattern information of the corresponding block.

6. The apparatus according to claim 1, wherein the means does not incorporate information, indicating whether or not the image block has been coded into the difference from the residual data of the corresponding block, into information of the coded image block.

7. A method for encoding an input video signal, comprising:
encoding the video signal according to a first scheme and outputting a bitstream of a first layer, and encoding the video signal according to a second scheme and outputting a bitstream of a second layer,
wherein encoding the video signal according to the first scheme includes a process for performing a prediction operation on an image block included in an arbitrary frame of the video signal to produce residual data of the image block, and selectively coding the residual data of the image block into difference data from residual data of a block, spatially corresponding to the image block, in a frame temporally coincident with the arbitrary frame and included in the bitstream of the second layer, based on a difference between coding information of the image block and coding information of the corresponding block.

8. The method according to claim 7, wherein the coding information difference is an absolute difference between a motion vector of the image block and a motion vector obtained by scaling a motion vector of the corresponding block by a ratio of resolution of the first layer to resolution of the second layer.

9. The method according to claim 8, wherein the process includes coding the residual data of the image block into the difference data from the residual data of the corresponding block if the absolute difference is less than or equal to one pixel.

10. The method according to claim 7, wherein the coding information of a macroblock, which is divided into sub-blocks to be coded into residual data, is pattern information including bit information individually assigned to each of the sub-blocks, the bit information having a value determined according to whether or not a corresponding one of the sub-blocks includes data having a value other than 0.

11. The method according to claim 10, wherein the means codes the residual data of the image block into the difference data from the residual data of the corresponding block if pattern information of the image block is identical to pattern information of the corresponding block.

12. The method according to claim 7, wherein, when the video signal is encoded according to the first scheme, information indicating whether or not the image block has been coded into the difference from the residual data of the corresponding block is not incorporated into information of the coded image block.

13. An apparatus for receiving and decoding a bitstream of a first layer and a bitstream of a second layer into a video signal, the apparatus comprising:
a first decoder for decoding the bitstream of the first layer according to a first scheme and reconstructing and outputting video frames having original images; and
a second decoder for extracting encoding information from the bitstream of the second layer and providing the extracted encoding information to the first decoder,
the first decoder including means for selectively adding data of a block, which spatially corresponds to a target block in an arbitrary frame in the bitstream of the first layer and which is included in a frame in the bitstream of the second layer temporally coincident with the arbitrary frame, to data of the target block based on a difference between coding information of the target block and coding information of the corresponding block, before reconstructing original pixel data of the target block based on data of a reference block of the target block.

14. The apparatus according to claim 13, wherein the coding information difference is an absolute difference between a motion vector of the target block and a motion vector obtained by scaling a motion vector of the corresponding block by a ratio of resolution of the first layer to resolution of the second layer.

15. The apparatus according to claim 14, wherein the means adds the data of the corresponding block to the data of the target block if the absolute difference is less than or equal to one pixel.

16. The apparatus according to claim 13, wherein the coding information of a macroblock, which is divided into sub-blocks to be coded into residual data, is pattern information including bit information individually assigned to each of the sub-blocks, the bit information having a value determined according to whether or not a corresponding one of the sub-blocks includes data having a value other than 0.

17. The apparatus according to claim 16, wherein the means adds the data of the corresponding block to the data of the target block if pattern information of the target block is identical to pattern information of the corresponding block.

18. A method for receiving and decoding a bitstream of a first layer into a video signal, the method comprising:
reconstructing and outputting video frames having original images by decoding the bitstream of the first layer according to a first scheme using encoding information extracted and provided from a received bitstream of a second layer,
wherein reconstructing and outputting the video frames includes a process for selectively adding data of a block, which spatially corresponds to a target block in an arbitrary frame in the bitstream of the first layer and which is included in a frame in the bitstream of the second layer temporally coincident with the arbitrary frame, to data of the target block based on a difference between coding information of the target block and coding information of the corresponding block, before reconstructing original pixel data of the target block based on data of a reference block of the target block.

19. The method according to claim 18, wherein the coding information difference is an absolute difference between a motion vector of the target block and a motion vector obtained by scaling a motion vector of the corresponding block by a ratio of resolution of the first layer to resolution of the second layer.

20. The method according to claim 19, wherein the process includes adding the data of the corresponding block to the data of the target block if the absolute difference is less than or equal to one pixel.

21. The method according to claim 18, wherein the coding information of a macroblock, which is divided into sub-blocks to be coded into residual data, is pattern information including bit information individually assigned to each of the sub-blocks, the bit information having a value determined according to whether or not a corresponding one of the sub-blocks includes data having a value other than 0.

22. The method according to claim 21, wherein the process includes adding the data of the corresponding block to the data of the target block if pattern information of the target block is identical to pattern information of the corresponding block.
